(19) United States
(12) Patent Application Publication
(10) Pub. No.: US 2016/0307220 A1
(43) Pub. Date: Oct. 20, 2016

(54) NON-TRANSITORY COMPUTER READABLE MEDIUM, INFORMATION PROCESSING APPARATUS, AND INFORMATION PROCESSING METHOD

(71) Applicant: FUJI XEROX CO., LTD., Tokyo (JP)

(72) Inventor: Masahiro SATO, Kanagawa (JP)

(73) Assignee: FUJI XEROX CO., LTD., Tokyo (JP)

(21) Appl. No.: 14/884,136

(22) Filed: Oct. 15, 2015

(30) Foreign Application Priority Data
Apr. 17, 2015 (JP) 2015-084793

(51) Int. Cl. G06Q 30/02

(52) U.S. Cl. CPC G06Q 30/0202

(57) ABSTRACT

A non-transitory computer readable medium stores a program causing a computer to execute a process for estimating willingness-to-buy. The process includes calculating including diving a first operation history of multiple operations performed by a user in electronic commerce, the dividing being performed on a basis of one of the multiple operations, calculating a degree of willingness-to-buy indicated by the one operation, the calculating being performed on a basis of multiple operations included in a second operation history obtained by dividing the first operation history, and calculating a temporal change in a degree of willingness-to-buy of the user in the electronic commerce.

### CROSS-REFERENCE TO RELATED APPLICATIONS

This application is based on and claims priority under 35 USC 119 from Japanese Patent Application No. 2015-084793 filed Apr. 17, 2015.

### BACKGROUND

### Technical Field

The present invention relates to a non-transitory computer readable medium, an information processing apparatus, and an information processing method.

### SUMMARY

According to an aspect of the invention, there is provided a non-transitory computer readable medium storing a program causing a computer to execute a process for estimating willingness-to-buy. The process includes calculating including diving a first operation history of multiple operations performed by a user in electronic commerce, the dividing being performed on a basis of one of the multiple operations, calculating a degree of willingness-to-buy indicated by the one operation, the calculating being performed on a basis of multiple operations included in a second operation history obtained by dividing the first operation history, and calculating a temporal change in a degree of willingness-to-buy of the user in the electronic commerce.

### BRIEF DESCRIPTION OF THE DRAWINGS

Exemplary embodiments of the present invention will be described in detail based on the following figures, wherein:

FIG. 1 is a block diagram illustrating a configuration example of an information processing apparatus according to an exemplary embodiment;

FIG. 2 is a schematic diagram illustrating a display example of a web page for browsing and purchasing an item;

FIG. 3 is a diagram for explaining an operation of calculating degrees of willingness-to-buy;

FIG. 4 is a graph illustrating an example of an operation of correcting a degree of willingness-to-buy (hereinafter, referred to as a degree-of-willingness-to-buy correction operation);

FIG. 5 is a graph illustrating another example of the degree-of-willingness-to-buy correction operation;

FIG. 6 is a graph illustrating yet another example of the degree-of-willingness-to-buy correction operation; and

FIG. 7 is a flowchart illustrating an example of operation of the information processing apparatus.

### DETAILED DESCRIPTION

### Exemplary Embodiment

### Configuration of Information Processing Apparatus

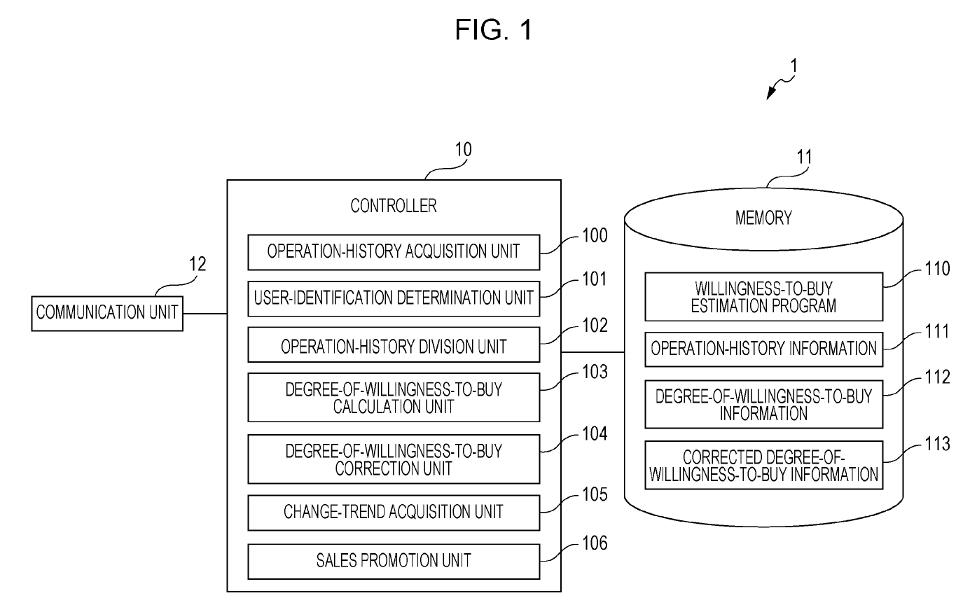

FIG. 1 is a block diagram illustrating a configuration example of an information processing apparatus according to an exemplary embodiment.

An information processing apparatus 1 includes a controller 10, a memory 11, and a communication unit 12. The controller 10 includes a central processing unit (CPU) and other components, controls units of the information processing apparatus 1, and executes various programs. The memory 11 includes a storage medium such as a flash memory and is used to store information. The communication unit 12 communicates with external apparatuses through a network.

The controller 10 executes a willingness-to-buy estimation program 110 (described later) to thereby function as an operation-history acquisition unit 100, a user-identification determination unit 101, an operation-history division unit 102, a degree-of-willingness-to-buy calculation unit 103, a degree-of-willingness-to-buy correction unit 104, a change-trend acquisition unit 105, a sales promotion unit 106, and other units.

The operation-history acquisition unit 100 acquires, from a service provider that provides services of electronic commerce, operation-history information 111 indicating a history of operations having been performed when a user has browsed and purchased items, for example, by electronic commerce in the past. In the electronic commerce, items and services are sold, purchased, and distributed through electronic information communications performed on a computer network. As the operation history, a history of clicks on a link and the like on a web page for providing an electronic commerce service may be recorded. Further, information such as the duration of browsing the web page, the number of browsed pages, and the order of page transitions may be recorded.

The user-identification determination unit 101 identifies a user who has performed multiple operations included in the operation-history information 111 and handles, as a history of operations, a series of operations performed by the same user. Further, the user-identification determination unit 101 handles, as a session, a series of operations performed in temporal succession in the history of the series of operations. Note that in the session, a series of communications are performed when the user utilizes an electronic commerce service. To define sessions, sessions are divided on the basis of, for example, an interval in which no communication is performed within a predetermined time.

The operation-history division unit 102 divides an operation history of multiple operations included in a specific session by using each operation as a reference operation. The operation-history division unit 102 thus obtains multiple operation histories respectively corresponding to multiple periods each including operations from the first operation to the corresponding reference operation. For example, in a case where operations in a specific session are from Click 1 to Click 8, an operation history of the operations is divided to obtain multiple operation histories in the following manner. Specifically, based on Click 1, an operation history of the operation (Click 1) included in a period from the operation start to a time point of Click 1 is obtained. Based on Click 2, an operation history of the operations (Clicks 1 and 2) included in a period from the operation start to a time point of Click 2 is obtained. Based on Click 3, an operation history of the operations (Clicks 1, 2, and 3) included in a period from the operation start to a time point of Click 3 is obtained.

The degree-of-willingness-to-buy calculation unit 103 calculates the degree of willingness-to-buy of the user observed at the time point of each operation, on the basis of the corresponding operation history of the period obtained by the division performed by the operation-history division unit 102. The degree-of-willingness-to-buy calculation unit 103 stores, in the memory 11, the result as degree-of-willingness-to-buy information 112. Note that the degree of willingness-to-buy may be calculated by using any technique, for example, by performing clustering on the basis of a common subsequence in a clickstream (Clickstream Clustering using Weighted Longest Common Subsequences, Arindam Banerjee and Joydeep Ghosh, SIAM, 2001) or a technique of predicting whether a user will purchase an item and the number of purchases of the item on the basis of time spent on a web page and the number of browsed pages (From Amazon to Apple-Modeling Online Retail Sales and Visit Behavior, Anastasios Panagiotelis, Michael S. Smith and Peter Danaher Journal of Business and Economic Statistics, 2013).

The degree-of-willingness-to-buy correction unit 104 corrects, in accordance with a predetermined criterion, the degree-of-willingness-to-buy information 112 calculated by the degree-of-willingness-to-buy calculation unit 103 and stores the result in the memory 11 as corrected degree-of-willingness-to-buy information 113. The correction is performed by using, for example, machine learning or pattern recognition. Specific examples of the correction will be described in detail in “Operation of Information Processing Apparatus”.

On the basis of temporal changes in degree of willingness-to-buy, the change-trend acquisition unit 105 acquires a change trend indicating, for example, a user is less or more willing to buy an item.

The sales promotion unit 106 performs sales promotion on the basis of the change trend acquired by the change-trend acquisition unit 105. For example, the sales promotion unit 106 performs sales promotion such as by presenting a discount coupon to the user in the case where the user is less willing to buy the item or by removing an advertisement in the case where the user is more willing to buy the item.

The memory 11 is used to store the willingness-to-buy estimation program 110 causing the controller 10 to function as the units 100 to 106 described above, the operation-history information 111, the degree-of-willingness-to-buy information 112, the corrected degree-of-willingness-to-buy information 113, and the like.

### Operation of Information Processing Apparatus

Next, (1) Basic Operation, (2) Degree-of-willingness-to-buy Calculation Operations, and (3) Sales Promotion Operation will be described as actions of the present exemplary embodiment.

### (1) Basic Operation

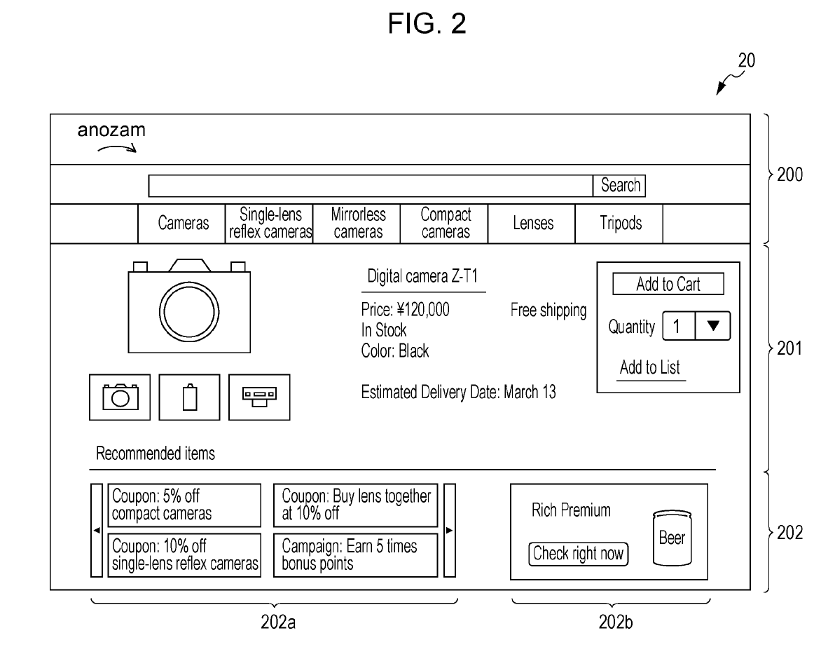

FIG. 2 is a schematic diagram illustrating a display example of a web page for browsing and purchasing an item.

First, a user accesses a web page to browse a desired item by using a terminal apparatus, for example, a personal computer (PC) of the user, the web page being managed by a server of an electronic commerce service provider. The terminal apparatus processes information transmitted from the server, and a web-page display screen 20 is thereby displayed on the display of the terminal apparatus, as illustrated in FIG. 2.

The web-page display screen 20 includes a menu display 200, an item information display 201, and a sales-promotion information display 202. The menu display 200 includes an input box for searching for an item, a selection button for selecting an item category, and the like. The item information display 201 includes photos, the name, and the price of an item, various buttons for purchasing the item, and the like. The sales-promotion information display 202 displays information for sales promotion in such a manner as to change the content of the information in accordance with the degree of willingness-to-buy of the user who is browsing an item displayed in the item information display 201.

The sales-promotion information display 202 displays a discount coupon 202a for a discount on the price of the item, an advertisement 202b related to the item or matching the taste of the user, and the like.

The server of the service provider records, as operation-history information, information caused by the user to be displayed on the web-page display screen 20 and operations performed on the web-page display screen 20.

The server of the service provider also transmits the operation-history information to the information processing apparatus 1 to request the information processing apparatus 1 to transmit information regarding an item to be displayed in the sales-promotion information display 202.

### (2) Degree-of-Willingness-to-Buy Calculation Operations

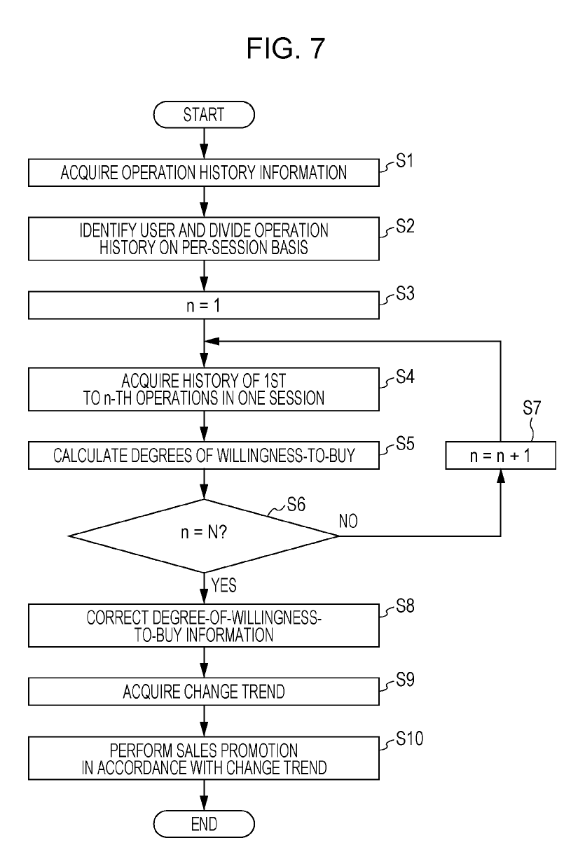

FIG. 7 is a flowchart illustrating an example of operation of the information processing apparatus 1.

The operation-history acquisition unit 100 acquires the operation-history information from the service provider and stores the operation-history information as the operation-history information 111 in the memory 11 (S1).

The user-identification determination unit 101 identifies a user who has performed multiple operations included in the operation-history information 111 and handles, as a history of operations, a series of operations performed by the same user. Further, the user-identification determination unit 101 handles, as a session, a series of operations performed in temporal succession in the history of the series of operations and thus divides the history of the series of operations on a per-session basis (S2).

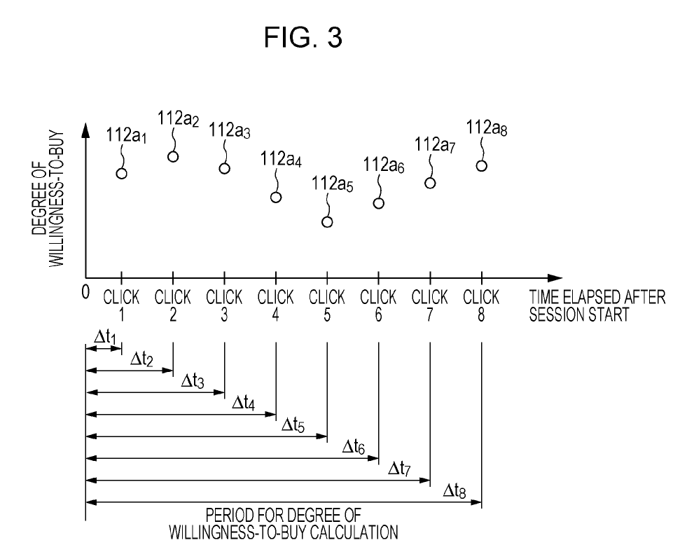

FIG. 3 is a diagram for explaining an operation of calculating degrees of willingness-to-buy.

The operation-history division unit 102 divides a history of sequential operations included in a specific session by using each operation as a reference operation and thus obtains multiple operation histories. For example, as illustrated in FIG. 3, in a case where operations in a specific session are from Click 1 to Click 8, an operation history of the operations is divided to obtain multiple operation histories in the following manner. Specifically, based on Click 1, an operation history of the operation (Click 1) included in a period from the operation start to a time point of Click 1 is obtained. Based on Click 2, an operation history of a series of operations (Clicks 1 and 2) included in a period from the operation start to a time point of Click 2 is obtained. Based on Click 3, an operation history of a series of operations (Clicks 1, 2, and 3) included in a period from the operation start to a time point of Click 3 is obtained (S4).

The degree-of-willingness-to-buy calculation unit 103 calculates degrees of willingness-to-buy 112a₁ to 112a₈ of the user at the time points of the respective operations, the calculation being performed on the basis of the operation histories corresponding to the periods resulting from the division performed by the operation-history division unit 102 (S5). The degree-of-willingness-to-buy calculation unit 103 stores the calculation results as the degree-of-willingness-to-buy information 112 in the memory 11. Steps S4 and S5 described above are performed for each period (S3, S6, and S7). Specifically, the calculation is performed in such a manner that the degree of willingness-to-buy 112a₁ is calculated on the basis of Click 1, the degree of willingness-to-buy 112a₂ is calculated on the basis of Clicks 1 and 2, and the degree of willingness-to-buy 112a₃ is calculated on the basis of Clicks 1, 2, and 3. Note that when the degrees of willingness-to-buy are calculated, all of the clicks from the start of operations do not have to be used, and a predetermined number of operations may be used. For example, in a case where the predetermined number of operations is 3, the degree of willingness-to-buy 112a₅ may be calculated on the basis of Clicks 3, 4, and 5. In addition, sequential operations do not have to be used, and the degree of willingness-to-buy 112a₅ may be calculated on the basis of Clicks 1, 3, and 5.

As in Degree-of-willingness-to-buy Correction Operations 1 to 3 (described later), the degree-of-willingness-to-buy correction unit 104 corrects, in accordance with a predetermined criterion, the degree-of-willingness-to-buy information 112 calculated by the degree-of-willingness-to-buy calculation unit 103 (S8). The degree-of-willingness-to-buy correction unit 104 stores the result as the corrected degree-of-willingness-to-buy information 113 in the memory 11.

### (2-1) Degree-of-Willingness-to-Buy Correction Operation 1

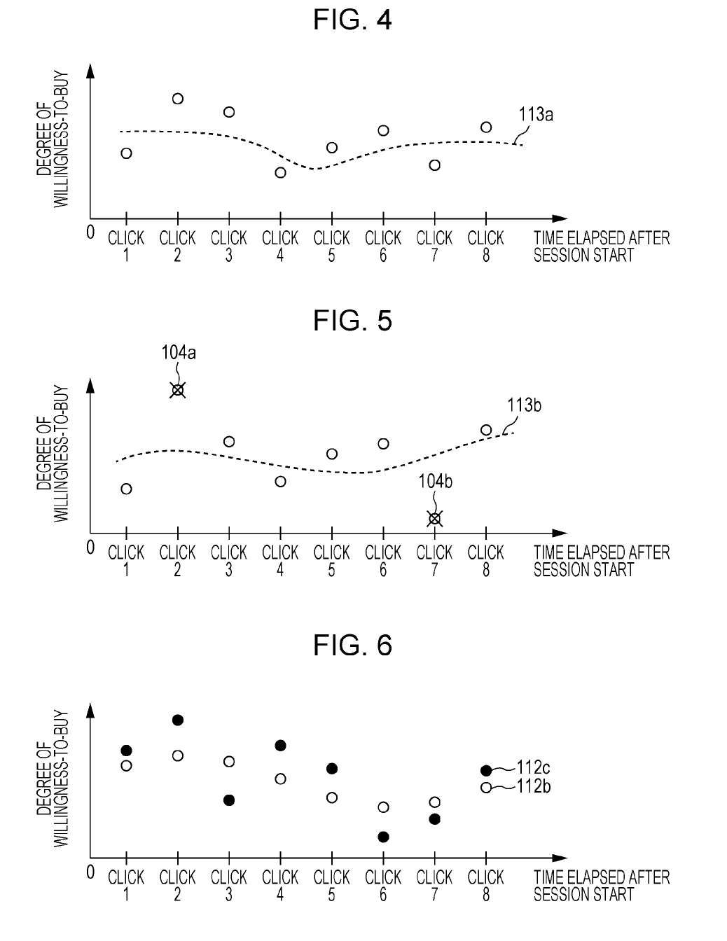

FIG. 4 is a graph illustrating an example of a degree-of-willingness-to-buy correction operation.

The degree-of-willingness-to-buy correction unit 104 performs smoothing by using a method such as a spline or a moving average on the assumption that the degree of willingness-to-buy continuously changes over time and obtains a corrected degree-of-willingness-to-buy 113a indicated by the dotted line in FIG. 4.

### (2-2) Degree-of-Willingness-to-Buy Correction Operation 2

FIG. 5 is a graph illustrating another example of the degree-of-willingness-to-buy correction operation.

The degree-of-willingness-to-buy correction unit 104 performs smoothing on the basis of values of the degrees of willingness-to-buy other than abnormal values 104a and 104b illustrated in FIG. 5 that largely deviate from a trend of the degree of willingness-to-buy and obtains a corrected degree-of-willingness-to-buy 113b indicated by the dotted line.

### (2-3) Degree-of-Willingness-to-Buy Correction Operation 3

FIG. 6 is a graph illustrating yet another example of the degree-of-willingness-to-buy correction operation.

The degree-of-willingness-to-buy correction unit 104 causes the degree-of-willingness-to-buy calculation unit 103 to calculate degrees of willingness-to-buy by using multiple techniques, methods, or prediction models, respectively, and performs comparison between degrees of willingness-to-buy 112b and 112c thus obtained as illustrated in FIG. 6. The degree of willingness-to-buy 112b is a calculation result exhibiting a smaller change in the degree of willingness-to-buy, and thus the degree-of-willingness-to-buy correction unit 104 uses the degree of willingness-to-buy 112b as a corrected degree of willingness-to-buy.

### (3) Sales Promotion Operation

The change-trend acquisition unit 105 acquires a change trend from a temporal change in the degree of willingness-to-buy, the change trend indicating, for example, whether the user is less or more willing to by the item (S9). For example, in the example in FIG. 3, the change-trend acquisition unit 105 acquires a change trend indicating that the user is less likely to buy the item in a period of the degrees of willingness-to-buy 112a₂ to 112a₅ corresponding to Click 2 to Click 5 and that the user is more likely to buy the item in a period of the degrees of willingness-to-buy 112a₅ to 112a₈ corresponding to Click 5 to Click 8.

The sales promotion unit 106 performs sales promotion on the basis of the change trend acquired by the change-trend acquisition unit 105 (S10). For example, in a case where the user is less likely to buy the item as in the period from Click 2 to Click 5 in FIG. 3, the sales promotion unit 106 presents the discount coupon 202a related to the browsed item in the sales-promotion information display 202 in FIG. 2 to encourage the user to buy the item. In a case where the user is more likely to buy the item as in the period from Click 5 to Click 8, the sales promotion unit 106 performs sales promotion such as by removing the advertisement 202b displayed in the sales-promotion information display 202 to make the user concentrate on the browsed item.

### Other Exemplary Embodiments

Note that the present invention is not limited to the exemplary embodiment described above, and various modifications may be made without departing from the gist of the present invention.

The functions of the units 100 to 106 of the controller 10 are implemented by using the program in the exemplary embodiment, but all or some of the units may be implemented by hardware such as an application specific integrated circuit (ASIC). In addition, the program used in the exemplary embodiment described above may be provided in such a manner as to be stored in a recording medium such as a compact disc read-only memory (CD-ROM). Moreover, mutual changes, deletions, additions, and the like of steps described above in the aforementioned exemplary embodiment may be made without departing from the gist of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for estimating willingness-to-buy, the process comprising:
calculating including diving a first operation history of a plurality of operations performed by a user in electronic commerce, the dividing being performed on a basis of one of the plurality of operations, calculating a degree of willingness-to-buy indicated by the one operation, the calculating being performed on a basis of a plurality of operations included in a second operation history obtained by dividing the first operation history, and calculating a temporal change in a degree of willingness-to-buy of the user in the electronic commerce.

2. The non-transitory computer readable medium according to claim 1,
wherein a plurality of degrees of willingness-to-buy are respectively calculated for the plurality of operations included in the first operation history, and the temporal change in the degree of willingness-to-buy of the user in the electronic commerce is calculated on a basis of the calculated plurality of degrees of willingness-to-buy,
the process further comprising:
acquiring a change trend from the temporal change in the degree of willingness-to-buy; and
performing sales promotion on a basis of the acquired change trend.

3. The non-transitory computer readable medium according to claim 1, the process further comprising:
correcting the calculated temporal change in the degree of willingness-to-buy by performing smoothing.

4. The non-transitory computer readable medium according to claim 2, the process further comprising:
correcting the calculated temporal change in the degree of willingness-to-buy by performing smoothing.

5. An information processing apparatus comprising:
a calculation unit that divides, on a basis of one of a plurality of operations performed by a user in electronic commerce, a first operation history of the plurality of operations, that calculates, on a basis of a plurality of operations included in a second operation history obtained by dividing the first operation history, a degree of willingness-to-buy indicated by the one operation, and that calculates a temporal change in a degree of willingness-to-buy of the user in the electronic commerce.

6. An information processing method comprising:
calculating including diving a first operation history of a plurality of operations performed by a user in electronic commerce, the dividing being performed on a basis of one of the plurality of operations, calculating a degree of willingness-to-buy indicated by the one operation, the calculating being performed on a basis of a plurality of operations included in a second operation history obtained by dividing the first operation history, and calculating a temporal change in a degree of willingness-to-buy of the user in the electronic commerce.
